(19) United States
(12) Patent Application Publication
(10) Pub. No.: US 2006/0292534 A1
(43) Pub. Date: Dec. 28, 2006

(54) Stationary virtual cycle system and method for operating the same

(76) Inventor: Christopher Tomes, Chicago, IL (US)

Correspondence Address: MCGUIREWOODS, LLP, 1750 TYSONS BLVD, SUITE 1800, MCLEAN, VA, 22102, US

(21) Appl. No.: 11/472,992

(22) Filed: Jun. 23, 2006

Related U.S. Application Data
(60) Provisional application No. 60/693,061, filed on Jun. 23, 2005.

(51) Int. Cl. A63B 71/00; A63B 69/00; G09B 19/00

(52) U.S. Cl. 434/247; 482/8

(57) ABSTRACT

The invention is directed generally to a method and apparatus for providing a stationary cycle, and more particularly to methods and devices for providing a user, such as a child, with a stationary cycle to navigate through a virtual world displayed to the user. More specifically, the invention allows a user to navigate within a virtual world by controlling a stationary cycle, thereby combining the interaction of a video game environment with the exercise afforded on a cycle. The user pedaling the cycle and controlling the handle bars. Based on these actions, the user can control navigation within the virtual world.

### CROSS REFERENCE TO RELATED APPLICATIONS

This application claims priority under 35 U.S.C. §119(e) to provisional U.S. Patent Application No. 60/693,061, filed on Jun. 23, 2005, the disclosure of which is herein expressly incorporated by reference in its entirety.

### BACKGROUND OF THE INVENTION

1. Field of the Invention

The invention is directed generally to a method and apparatus for providing a stationary virtual cycle, and more particularly to methods and devices for providing a user, such as a child, with a stationary cycle to navigate through a virtual world.

2. Related Art

Cycling provides enjoyment and exercise to many people. Users can ride cycles in numerous terrains, including cities, off road trails, and bike trails. Further, the cycle rider can pedal as fast or slow as desired. This can result in a harder, more strenuous form of exercise, or in a slower, less stressful exercise, based on the preference of the user. However, many people, including children, do not get the exercise that they need. Television and video games can contribute to a generally sedentary lifestyle. This lifestyle coupled with poor nutrition and eating habits can lead to obesity and health problems.

As noted above, video games can contribute to an unhealthy lifestyle. In particular, many people elect to play video games, which require little or no physical activity, in lieu of actual physical activities. While actual physical exercise is desirable for a healthy lifestyle, the lure of video games, especially among children, can be quite strong and difficult to overcome. Accordingly, there is a need for increasing physical activity.

### SUMMARY OF THE INVENTION

The invention meets the above needs and avoids the disadvantages and drawbacks of the prior art by combining an activity that requires physical activity with a video game interaction.

More specifically, the invention allows a user to navigate within an animated virtual world by physically controlling a stationary cycle, thereby combining the interaction of a video game environment with the exercise afforded by a cycle.

The invention may be implemented in a number of ways. According to one aspect of the invention, a system for navigating within a virtual world is provided, where the system includes a stationary cycle including a handle bar and a rotateable crank with two pedals and a display device. The system further includes at least one directional device connected to the handle bar, the at least one directional device being activated by the user to generate a directional signal indicative of movement of the handle bar, and at least one sensor device arranged proximate to the rotateable crank, the at least one sensor device generating a crank signal based on rotational movement of the rotateable crank. The system also includes at least one processor operatively connected to the display device, the at least one directional device and the at least one sensor device, wherein the at least one processor provides virtual world content to the display device, and wherein the at least one processor varies the virtual world content based at least in part on at least one of the directional signal and the crank signal.

The virtual world may be an animated world. In addition, the at least one directional device is an optical sensor. The handle bar may include a handle support having a disk attached thereto, and the at least one optical sensor may sense rotation of the disk. The at least one sensor device may further include a disk attached to the rotateable crank and at least one optical sensor arranged proximate to the rotateable crank such that when the rotateable crank rotates, the optical sensor senses the rotation of the disk. The system may also include readable code resident on the at least one processor and cause the at least one processor to provide the virtual world content to the display device. The stationary cycle may be sized for a child.

According to an additional aspect of the invention, a method for navigating though a virtual world via a stationary cycle comprising a handlebar and a crank, includes the steps of displaying content related to the virtual world, receiving at least one directional signal indicative of the handlebar by the user, receiving at least one crank signal indicative of rotational movement of the crank, the at least one crank signal being received from at least one sensor device arranged proximate the moveable crank, and adjusting the content of the displayed virtual world based at least in part on at least one of the activation signal and the at least one crank signal.

The virtual world may be an animated world, and the directional device may be an optical sensor. The handle bar may include a handle support having a disk attached thereto, and the method may further comprise the step of sensing rotation of the disk via the optical sensor. The step of receiving at least one crank signal may further include the steps of moving a disk in proximity to an optical sensor, wherein the movement of the disk is based on the rotation of the crank, sensing movement of the disk at the optical sensor, and generating the crank signal at the magnetic sensor. The stationary cycle may be sized for a child.

According to a further aspect of the invention, a system for navigating in a virtual world includes a stationary bicycle including a handlebar and a rotateable crank with two pedals, a means for display, at least one means for indicating direction connected to the handlebar, at least one means for sensing arranged proximate to the moveable crank, the at least one means for sensing converting movement of the moveable crank into a crank signal, and at least one means for processing operatively connected to the means for display, the at least one means for activating, and the at least one means for sensing, wherein the at least one means for processing provides virtual world content to the means for display, and wherein the at least one means for processing varies the virtual world content based at least in part on at least one of the directional signal and the crank signal.

The virtual world may be an animated world. The handlebar may include two handle grips, and the at least one means for indicating direction may include a means for indicating direction on each of the handle grips. The system may also include readable code resident on the means for processing and causing the means for processing to provide the virtual world content. The stationary cycle may be sized for a child.

According to another aspect of the invention, a computer readable medium having code to cause a processor to navigate though a virtual world via a stationary cycle is provided, where the stationary cycle includes a handlebar and a crank. The medium includes code for displaying content related to a virtual world, code for receiving at least one directional signal indicative of movement of the handlebar, the movement being by the user to indicate a direction, code for receiving at least one crank signal indicative of rotational movement of the crank, the at least one crank signal being received from at least one sensor device arranged proximate the moveable crank, and code for adjusting the content of the displayed virtual world based at least in part on at least one of the directional signal and the at least one crank signal.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 illustrates a stationary virtual cycle system constructed according to principles of the invention;

FIG. 2 illustrates a handle bar having a rotational sensor for indicating a direction constructed according to principles of the invention;

FIG. 3 illustrates a pedal and crank having a circular disk attached for determining movement of the crank constructed according to principles of the invention;

FIGS. 4A and 4B illustrate the arrangement of the two optical sensors in relation to the rotary encoder wheel constructed according to principles of the invention;

FIG. 5 schematically illustrates a processor and control components for controlling processing within a virtual world constructed according to principles of the invention;

FIG. 6 illustrates a prospective view of another stationary virtual cycle system constructed according to principles of the invention;

FIG. 7 illustrates a side view of the stationary virtual cycle system illustrated in FIG. 6;

FIG. 8 illustrates a front view of the stationary virtual cycle system illustrated in FIG. 6;

FIG. 9 illustrates a top view of the stationary virtual cycle system illustrated in FIG. 6.

FIG. 10 illustrates a pedal and crank having a sensor in proximity of the crank's rotation for determining movement of the crank constructed according to principles of the invention;

FIG. 11 illustrates a handle bar having directional buttons for indicating a direction constructed according to principles of the invention;

FIG. 12 schematically illustrates a processor and control components for controlling processing within a virtual world constructed according to principles of the invention; and

FIG. 13 schematically illustrates a cable connecting the processor and components of FIG. 12 constructed according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The stationary cycle according to principles of the invention may comprise a stationary exercise-type cycle structure. Although a child-sized stationary exercise-type cycle structure will be specifically described herein, it is understood that adult sized cycles may also be used. The cycle structure may have simple electronic components that sense when the child has pedaled a complete revolution, and when they've pressed or released a left or a right directional button mounted on the handle bars. This triggering information may be sent to a processor for controlling a display unit via status control lines, allowing the child (or adult) to control navigation through an animated virtual world. The invention will now be described in greater detail below.

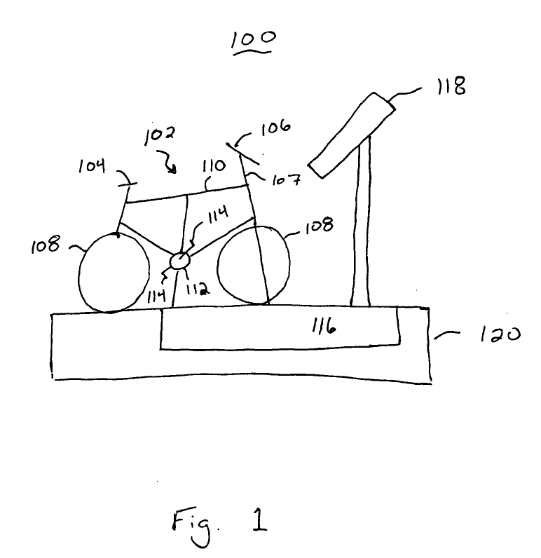

FIG. 1 illustrates a stationary virtual cycle system according to principles of the invention. A stationary cycle system 100 includes a cycle 102 mounted on a stand 120. The cycle 102 includes a frame 110 supporting a seat 104, handle bars 106, a handle bar support 107, and a crank 112. Pedals 114 are attached to the crank using conventional methods. Wheels 108 may be included and may be attached to the frame 110. The wheels 108 may be fixedly attached to the frame 110 or the stand 120. Alternatively, the wheels 108 may be free to rotate relative to the frame 110. A display 118 is located in front of the cycle 102 to allow a user to use the cycle 102 while viewing the display 118. A user views the animated virtual world on the display 118 while on the cycle 102.

A processor 116 is operatively connected to the display 118 and controls what is displayed to the user. A virtual world may be associated with the stationary virtual cycle system 100. While the virtual world described herein is generally described as an animated virtual world, it is understood that a virtual world comprising video or a combination of animation and video may also be used. The processor 116 receives inputs indicative of a user's manipulation of the cycle 102. Based on the inputs, the processor 116 controls the display 118 and the navigation through the virtual world. The inputs from the cycle 102 may be from sensors (not shown in FIG. 1), buttons, levers or others devices. Although the processor 116 is shown in a location in the stand 120, it is understood that it may be located in other places. According to an embodiment of the invention, the processor 116 may be integrated with the display 118. The processor 116 may be any type of processor, such as a standard central processing unit, that is capable of running software. Various types of sensors

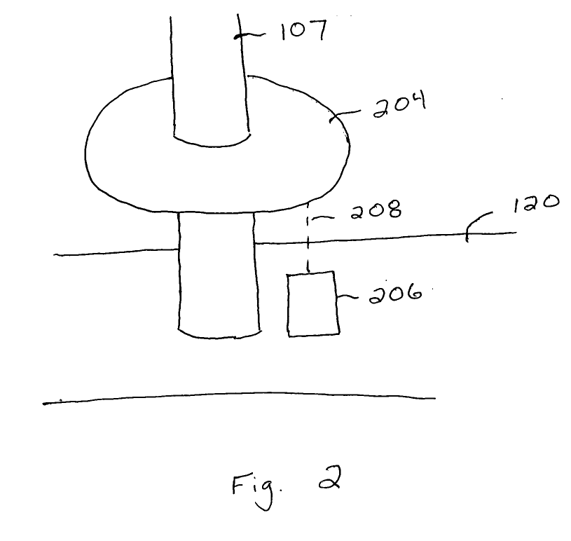

FIG. 2 illustrates a handle bar having a rotational sensor for indicating a direction constructed according to principles of the invention. The handlebar support 107 has located on it a circular disk 204 that is fixed relative to the handlebar support. When the handle bars 106 are turned, the circular disk 204 rotates. An optical sensor 206 is located on the base 120. According to an embodiment of the invention, the optical sensor 206 can distinguish 1000 unique positions per 360 degrees of rotation of the circular disk 204. As the circular disk 204 passes through the line-of-sight 208 of the optical sensor 206, the optical sensor detects the position of the handle bars 106. The optical sensor 206 may be powered by a 5V supplied by a cable, such as a USB cable, that connects the optical sensor 206 to the processor 116. By way of example, the circular disk 204 may be a US Digital HUBDISK-1000-500-2-I disk, while the optical sensor 206 may be an Agilent HEDS-9040-B00 optical sensor. Other types of disk and sensor may also be used. The optical sensor 206 generates electrical signals based on the position of the handle bars 106 and sends the electrical signals to a microcontroller within the sensor 206. According to an embodiment of the invention, the microcontroller may encode the electrical signal as a HID mouse X-coordinate.

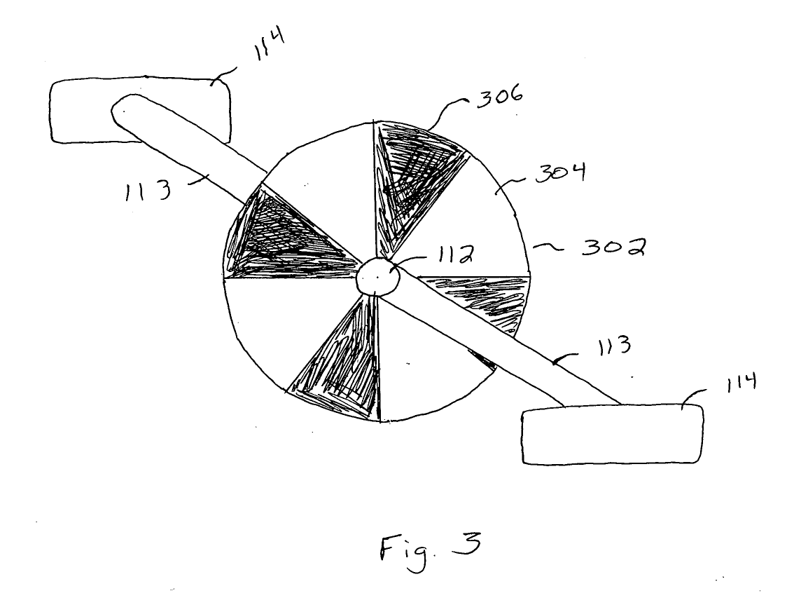

FIG. 3 illustrates a pedal and crank having a circular disk attached for determining movement of the crank constructed according to principles of the invention. The rotational sensor is a combination of two optical sensors 308, 312 and a rotary encoder wheel 302. The rotary encoder wheel 302 is a disc attached to the crank 112. According to an embodiment of the invention, the rotary encoder wheel may four equally spaced slots 304, with each slot 304 having a radial length of about 45°. Other number of slots and sizes may also be used. The rotary encoder wheel 302 thus has slots 304 and shaded portions 306. As a user engages the pedals 114 to rotationally move the crank 112, the rotary encoder wheel 302 also rotationally moves.

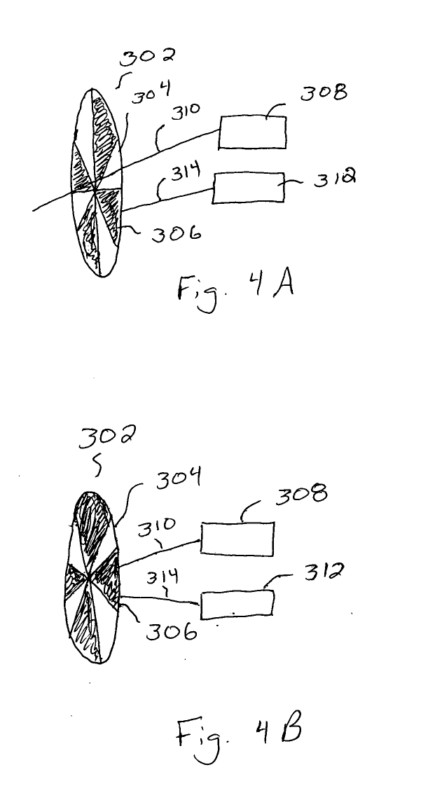

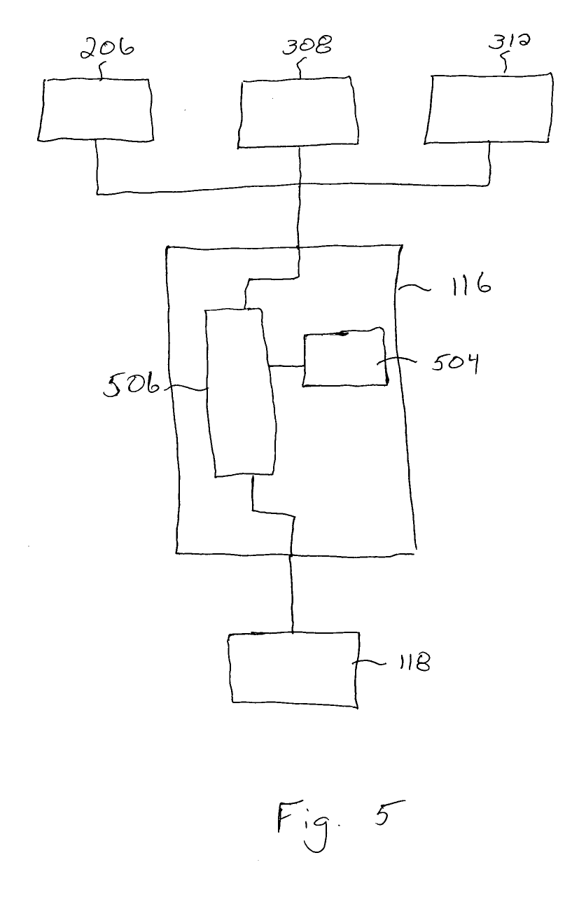

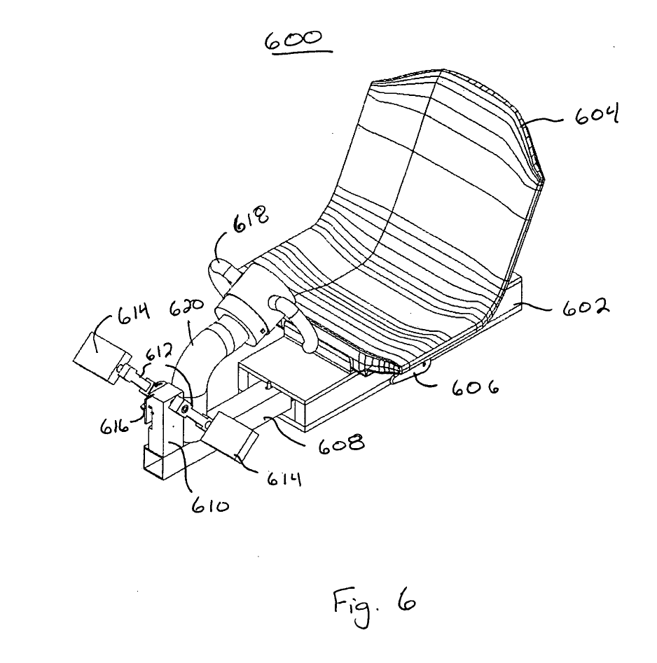

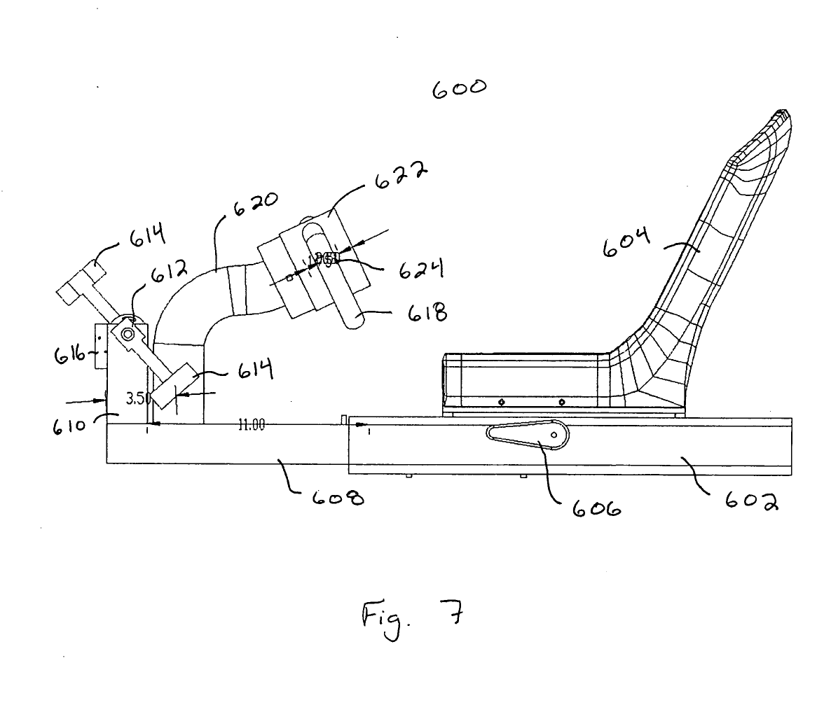

FIGS. 4A and 4B illustrate the arrangement of the two optical sensors 308 and 312 in relation to the rotary encoder wheel 302. Specifically, the optical sensors 308 and 312 are arranged such that the beam 310 of optical sensor 308 is broken right before the beam 314 of the second sensor 312 is broken. This arrangement allows the processor 116 to determine the rotational direction in which the crank 112 is being turned. Thus, as shown in FIG. 4A, the rotary encoder wheel 302 interrupts the beam 314 of optical sensor 312, while allowing the beam 308 of optical sensor 310 to pass. In FIG. 4B, the wheel rotates in direction of arrow 316 so that the rotary encoder wheel 302 interrupts both the beam 314 of optical sensor 312, and the beam 308 of optical sensor 310. By way of example, the optical sensors 308, 310 may be an Omron EE-SX672 optical sensor, which sends a high voltage when the beam is broken and a low voltage when it is not broken. Other types of disk and sensor may also be used.

The user's pedaling and turn actions as detected by the optical sensors 206, 308 and 312 may be accumulated by the microcontrollers within the sensors. FIG. 5 schematically illustrates a processor and control components for controlling processing within a virtual world constructed according to principles of the invention. The inputs from the optical sensors 206, 308 and 312, which are the control components, may be are sent to the operating system 502 at a regular interval. According to an embodiment of the invention, the input signals may be encoded in a USB HID mouse event and may be sent to the processor 116 through a cable 502, such as a USB cable. Other types of cables may also be used. By encoding signals in a standard USB HID packet, the use of special drivers or protocols to deliver user input to the gaming application may be avoided, thereby significantly simplifying the necessary software. This may also allow a system according to the invention to be used on any operating system that can capture USB keyboard and mouse events. In addition, inputs may be directly visualized without the gaming application because in a generic operating system environment, pedaling would move the mouse cursor down on the screen and turning the handle bars left and right will move the mouse cursor left and right, respectively, on the screen.

The processor 116 includes an operating system 504, such as Microsoft's Windows XP operating system, a graphical distribution of Linux, or other operating system. In addition, the processor 116 includes a communications program 506 that communicates with the hardware. The communications program 506 may be written in C++ or other computer language. According to an embodiment of the invention, the optical sensors 206, 308, and 312 may be detected by the operating system 504 as a standard Human Interface Device (HID). An HID is a computer device that interacts directly with and takes input from humans, such as a keyboard, mouse, joystick, and the like. The resulting signals that correspond to the movement of the pedals and the handlebar 116 turns may be encoded as mouse coordinates. Mouse scroll signals may be sent every time a mouse coordinate get sent, so that when the events are captured, the communications program 506 knows how many signals have been accumulated by the operating system 504. The communications program 506 captures the operating system 504 mouse and keyboard events and translates the mouse coordinates transmitted from the hardware (e.g., the optical sensors 206, 308, and 312) to control the cycle. According to an embodiment of the invention, the micro-controllers in the optical sensors 206, 308 and 312 send the accumulated input from the sensors as a USB HID mouse packet at a regular interval (approximately every 40 ms).

For the turning, the absolute position of the circular disk 204 on the handle bars 106 is translated into a number within a range. By way of example, the numbers may range from −127 to 127 and be stored in the mouse X-coordinate. The number −127 may denote the handle bars 106 turned all the way to the left, the number 127 may denote the handle bars 106 turned all the way to the right, and the number 0 may be centered. According to an embodiment of the invention, the most recent absolute position of the handle bars may be sent when the microcontroller transmits the USB HID packet. Other numbering schemes may also be used.

For the pedaling, the accumulated number of transitions from high to low in the forward direction may be sent as a positive mouse Y-coordinate. For example, if the user has pedaled one full revolution, a +4 may be sent for the mouse Y-coordinate, since there are 4 slots in the rotary encoder wheel and one full revolution would cause the optical sensors beams to be broken and then unbroken four times. Other numbering schemes may also be used.

Further to this example, a +1 is sent for the mouse wheel every time a a mouse packet is sent from the micro-controller of the optical sensors 206, 308 and 312 to the processor 116. This may be performed because acquiring the operating system events from within the communications program 504 may be non-deterministic. Thus, when mouse input events are captured from the operating system 504, the number of mouse events that have been sent based on the mouse wheel value the operating system 504 has accumulated.

The communications program 506 may also be responsible for rendering the virtual world provided to display 116. The communications program 506 may make changes in the displayed animation based on the inputs received from optical sensors 206, 308 and 312, creating the illusion that the user is actually physically navigating through the animation.

For example, if the user is traveling down a road, there may be a split off to the right. When the user turns the handle bars 116 to the right, the animation then branches off to the right. In addition, for every forward pedal event of the crank 112 that is received, the user's velocity is incremented as long as the user has not attained the maximum allowable velocity. The velocity may decay over time, so if the user stops pedaling to turn the crank 112, the animation would slow down gradually until the user comes to a complete stop, much like the real experience of pedaling a bicycle.

According to an embodiment of the invention, the communications program 506 may update the display at specific intervals, e.g., every 32 ms, so that a specific frame rate, e.g., around 30 frames per second, is obtained to create a fluid user experience. This may be done as a human often cannot detect visual changes faster than a certain number of changes, e.g., 30 frames per second, on a standard computer monitor.

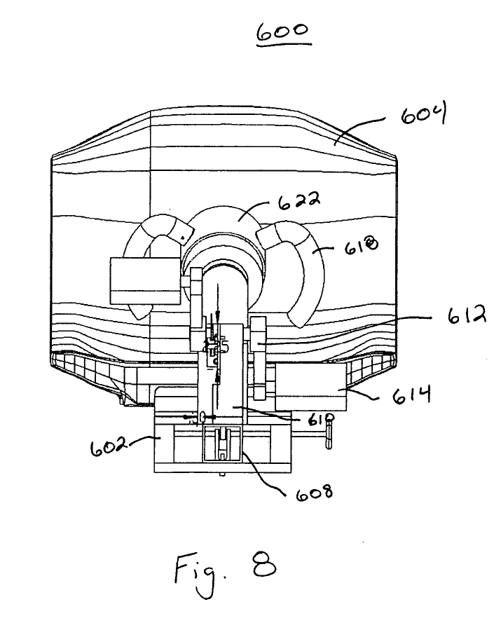

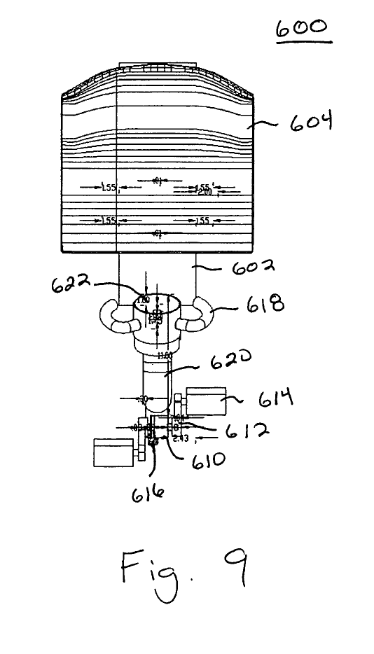

FIG. 6 illustrates a prospective view of the stationary virtual cycle system illustrated in FIG. 6. FIG. 7 illustrates a side view of another stationary virtual cycle system according to principles of the invention. FIG. 8 illustrates a front view of the stationary virtual cycle system illustrated in FIG. 6. FIG. 9 illustrates a top view of the stationary virtual cycle system illustrated in FIG. 6. A stationary virtual cycle system 600 includes a base 602 and a support rail 608. The base 602 is slideably attached to the support rail 608. A seat 604 is attached to the base 602. An adjustment lever 606 is attached to the seat base 602. When in a first position, the adjustment lever 606 maintains the seat 604 in fixed position relative to the support rail 608. When in a second position, the adjustment lever 606 allows a user to slideably move the seat 604 in relation to the support rail 608.

The stationary virtual cycle system 600 also includes a crank 612 rotatably attached to a crank support 610. Two pedals 614 are attached to the crank 612. A sensor device 616 is fixed to a crank support 610. As the user engages the pedals 614 and rotates the crank 612, the sensor device 616 generates a signal indicative of the rotation of the crank 612. This may be achieved by using the rotary encoder wheel 302 and the optical sensors 308, 312 described above with respect to FIG. 3, but not shown in FIGS. 6-9.

The stationary virtual cycle system 600 also includes a handle support 620 and a handle attachment 622. Two handle grips 618 are attached to the handle attachment 622. As the user takes the handle grip 116, a signal is generated from a sensor device (not shown) indicative of the movement of the handle grip by the user. This may be achieved by using the disk 204 and the optical sensor 206 described above with respect to FIG. 2, but not shown in FIGS. 6-9.

As with the embodiment described with respect to FIG. 1, a processor (not shown) receives the signals from the sensor device 616 and the directional buttons 624 to allow the user to navigate through a virtual world as described above.

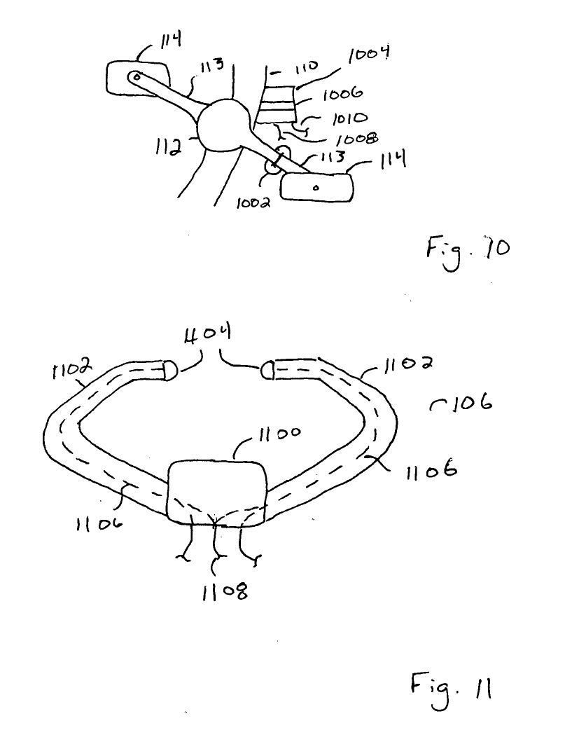

FIG. 10 illustrates a pedal and crank having a sensor in proximity of the crank for determining rotational movement of the crank according to principles of the invention. Crank 112 is rotationally attached to the frame 110. This rotational connection may be achieved using any rotational connection know in the art of cycles. The crank 112 includes two extensions 113 having a pedal 114 connected to each.

A sensor device 1004 having a magnetic sensor 1006 may be attached to the frame 110. A magnet 1002 may be attached to at least one of the extensions 113. The magnet 1002 and the sensor device 1004 are positioned such that the magnet 202 passes by the magnetic sensor 1006 of the sensor device 1004 as the crank 112 and the extensions 113 rotate. The sensor device 1004 can generate a signal indicative of the rotational speed of the crank 112. Sensor device 1004 includes a power input 1008 and a sensor signal connector 1010, such as a cable, electrical wire, or other type of connector. Sensor signal connector 1010 is operatively connected to processor 116 to send a signal from the sensor device 1004 to the processor 116. The sensor device 1004 may be any type of conventional sensor. Further, although the sensor device 1002 has been described with respect to a magnetic sensor, it is understood that other types of sensors for determining rotational speed or movement, such as optical sensors, may also be used.

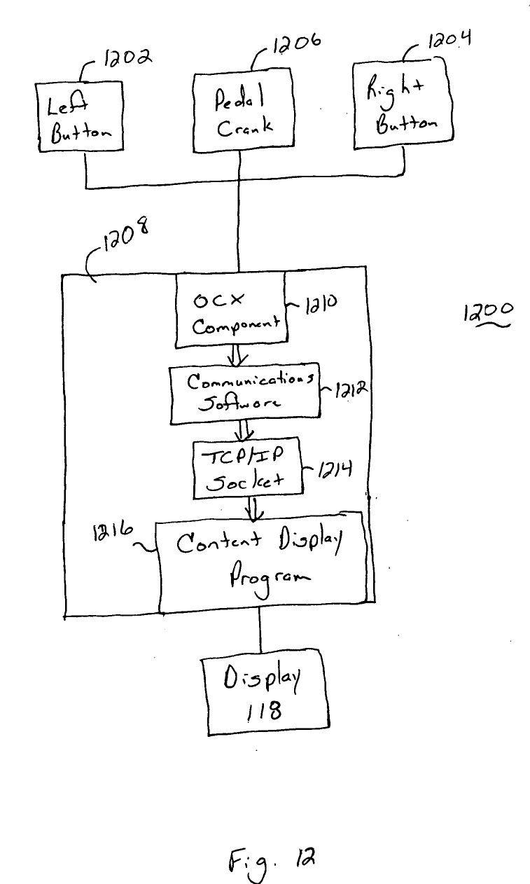

FIG. 11 illustrates a handle bar having directional buttons for indicating a direction according to principles of the invention. The handle bar 106 includes a handle base 1100 with two handle grips 1102. At the end of each handle grip 1102 is a directional button 1104. When operating the stationary virtual cycle system 100, a user activates a directional button 1104 to control the user's movement through the virtual world. By way of example, when the user desires to move the user's character toward the right in the virtual world, the user activates the directional button 1104 on the right. A connector 1106 located within each handle grip 1102, is attached to each directional button 1104. The connector 1106 is operatively connected to the processor 116 to provide signals from the directional button 1104 indicative of the activation of the directional button 1104. A power connector 1108 provides power for the directional buttons 1104. it should be noted that other handle bar and/or directional input devices are also contemplated by the invention.

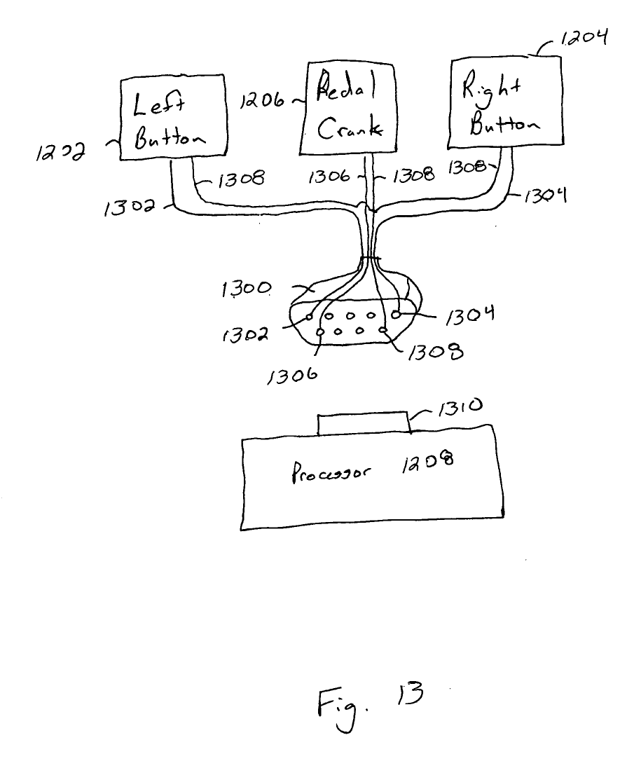

FIG. 12 schematically illustrates a processor and control components for navigation within a virtual world according to principles of the invention. A processor system 1200 includes a processor 1208. Control components include the directional buttons 1104 implemented as a left directional button 1202, and a right directional button 1204, and the sensor device 1004 as a crank signal device 1206 to provide input signals to the processor 1208. The input signals from the left directional button 1202 and the right directional button 1204 indicate when the user activates the directional button 1202 or the right directional button 1204. The inputs from the crank signal device 1206 provide indications of the movement of the crank.

According to an embodiment of the invention, the processor 1208 may run Microsoft's Windows XP operating system. The processor 1208 includes communication software 1212, such as Microsoft Visual Basic (“VB”), which communicates with the control components. The communications software 1212 includes an OSX component 1210, such as an MSCOMM, that receives the input signals from the control components, e.g., the left directional button 1202, the right directional button 1204 and the crank signal device 1206. By way of example, the VB program may use a standard OCX component called MSCOMM to directly access a serial port (not shown), such as the RS-232 serial port. The RS-232 serial port connects the processor 1208 with the left directional button 1202, the right directional button 1204 and the crank signal device 1206. When the VB program 1212 first starts, the VB program 1212 sets the MSCOMM DTR enable attribute to “True” then opens the COM port, causing the DTR pin to stay at a particular voltage, such as 11.2 V. DTR means “Data Terminal Ready,” and is conventionally designed as a signal line, allowing a device connected to the computer to signal that it is ready to communicate. Having the DTR supply voltage to the circuit is a different usage of the COM port, and allows the use of the left directional button 1202, the right directional button 1204 and the crank signal device 1206 without requiring a battery. Other operating systems, software and hardware languages, as well as hardware components, may also be used.

FIG. 13 schematically illustrates a cable 1300 connecting the processor and control components of FIG. 12 according to principles of the invention. Signals indicative of the user's actions on the left directional button 1202, the right directional button 1204 and the crank signal device 1206 may be then sent back to the processor 1208 through a cable 1302, such as an RS-232 serial cable, and providing a usage of the control lines of the cable 1302. In the example of an RS-232 cable, the crank signal device 1206 is connected to the RI (Ring Indicator) pin 1306, the left directional button 1202 output is connected to the DSR (Data Set Ready) pin 1302, and the right directional button 1204 output is connected to the DCD (Data Carrier Detect) pin 1304 for connection to the processor 1208. Generally, these control lines 1302, 1304, 1306 are intended for the connecting equipment to signal to the computer a change in its status. In the present invention, the control lines 1302, 1304, 1306 are used to actually convey user input data to the processor 1208. By communicating to the processor 1208 via these control lines, as opposed to using the standard TD (Transmit Data) line, the use of a serial driver chip may be avoided, which may simplify the circuit. A specific voltage, such as 11.2 V, is provided through pin 1308 to provide power to the left directional button 1202, the right directional button 1204 and the crank signal device 1206. The processor 1208 includes an input port 1370, such as an RS-232 port. Other connections and components may also be used.

According to an exemplary embodiment of the invention, when sensing user input, a DTR signal of 11.2 volts travels down a standard RS-232 cable 1302 from the processor 1206 to the cycle 102, where it is sent to the control components components (1202, 1204, 1206) that detect the user's input. The left directional button 1202 and the right directional button 1204, mounted on the handle bars 106, may be standard momentary pushbuttons, closing the circuit when depressed, and opening it when released. The crank signal device 1206 may be a normally closed magnetic switch, opening when a magnet mounted on the cycle's pedal crank passes by. One such magnetic switch is available at Radio Shack (Model # 129-1296).

When the user presses a button or pedals the magnet near the magnetic switch, the corresponding control line changes state, triggering the OCX component 1210 which then sends a message to the communications software program 1212. The left directional button 1202, the right directional button 1204 and the crank signal device 1206 often send more than one message per trigger, so communications software program 1212 may watch for incoming signals. Moreover, these signals may come very fast (i.e., within 2 ms of each other) so that there may be hardware spikes and not actually separate user input actions. This is commonly known as “debouncing.”

Once the signals have been processed, the communications software program 1212 communicates this information via a standard TCP/IP socket connection 1214, such as an XML socket, to the content display program 1216, such as a Macromedia Flash program, which is the software responsible for displaying the virtual world and modifying its presentation to reflect user input.

The content display program 1216 receives messages that the user has pressed a button or pedaled a revolution from communications software program 1212 through a TCP/IP Socket connection 1214. The content display program 1216 then makes changes in the displayed animated virtual world in the display 118 based on these messages, creating the illusion that the user is actually navigating through the animation. By way of example, the animation shows the user traveling down a road. The user moves forward along the road based in part on the pedaling by the user. As the user moves along the road, there maybe a split off to the right. The user presses the right button at that point and the animation then moves the user to take the branch off to the right.

According to an embodiment of the invention, the content display program 1216 may process the cycle information received from communications software program 1212 in order to present a smoother, more realistic experience. By way of example, each time the content display program 1216 gets a cycle message, it calculates an average “Cycles Per Second” (CPS). The content display program 1216 calculates the difference between the last CPS and this new CPS. Based on the timing interval of the animation loop, the content display program 1216 calculates an amount to add or subtract each time through the loop such that, should the user continue to pedal at this same new rate, would reach the new CPS the next time a cycle would be detected. This algorithm may allow the speed the animation should play at to “float” up and down in sync with the user's pedaling. Other operating systems, software and hardware languages, as well as hardware components, may also be used.

According to an embodiment of the invention, certain hardware may limit maximum animation rates to about 113 frames per second, while certain content display programs 1216, such as Macromedia Flash, will not allow the frames per second to be less then one or be a decimal value. To overcome these limitations, the animation frames may “manually” advance based on a timer. The calculated decimal frame rate may be rounded, thereby advancing to the next frame of the animation only when the rounded value changes. When the user pedals quickly, the animation loop begins skipping frames, and creating an illusion of higher speed beyond what the normal “play every frame” approach would allow.

Other animation products and content display programs, such as Director from Macromedia, may be used to present and allow the user to navigate through a true 3D virtual world. Using the stationary cycle system according to principles of the invention, a child or adult controls navigation through an animated virtual world. For example, the child may steer, interact with characters, objects, or other things. A child may select a particular animated virtual world, or may be presented with an animated virtual world. Content for a device may be updated periodically, such as through a wireless transmission, a download from a storage media, or other methods. Virtual worlds may be related to animated shows, movies, cartoons, comics, and fictional tales. Other virtual worlds may be based on one or more characters, such as stars, athletes, characters associated with particular brands. By way of one example a virtual world may be based on Ronald McDonald™ and a user may navigate through Ronald McDonald land™. In this example, the stationary virtual cycle that provides navigation within Ronald McDonald land™ could be located in a McDonalds™ restaurant.

While the invention has been described in terms of exemplary embodiments, those skilled in the art will recognize that the invention can be practiced with modifications in the spirit and scope of the appended claims. For example, while the embodiments described above have been directed to a stationary cycle using particular sensors, it is understood that other types of sensors may also be used. In addition, while specific embodiments have been described, it is understood that different components of embodiments may be used. For example, the buttons in the handle bars may be used with an optical sensor for detecting rotation of the crank. These examples given above are merely illustrative and are not meant to be an exhaustive list of all possible designs, embodiments, applications or modifications of the invention.

What is claimed is:

1. A system for navigating within a virtual world, the system comprising:
a stationary cycle including a handle bar and a rotateable crank with two pedals;
a display device;
at least one directional device connected to said handle bar, said at least one directional device being activated by the user to generate a directional signal indicative of movement of said handle bar;
at least one sensor device arranged proximate to said rotateable crank, said at least one sensor device generating a crank signal based on rotational movement of said rotateable crank; and
at least one processor operatively connected to said display device, said at least one directional device and said at least one sensor device, wherein said at least one processor provides virtual world content to said display device, and wherein said at least one processor varies the virtual world content based at least in part on at least one of the directional signal and the crank signal.

2. The system according to claim 1, wherein the virtual world is an animated world.

3. The system according to claim 1, wherein said at least one directional device is an optical sensor.

4. The system according to claim 3, wherein said handle bar includes a handle support having a disk attached thereto, and wherein said at least one optical sensor senses rotation of said disk.

5. The system according to claim 1, wherein said at least one sensor device further comprises:
a disk attached to said rotateable crank; and
at least one optical sensor arranged proximate to said rotateable crank such that when said rotateable crank rotates, said optical sensor senses the rotation of said disk.

6. The system according to claim 1, further comprising readable code resident on said at least one processor, said readable code causing said at least one processor to provide the virtual world content to said display device.

7. The system according to claim 1, wherein said stationary cycle is sized for a child.

8. A method for navigating though a virtual world via a stationary cycle, the stationary cycle comprising a handlebar and a crank, said method comprising the steps of:
displaying content related to the virtual world;
receiving at least one directional signal indicative of the handlebar by the user;
receiving at least one crank signal indicative of rotational movement of the crank, the at least one crank signal being received from at least one sensor device arranged proximate the moveable crank; and
adjusting the content of the displayed virtual world based at least in part on at least one of the activation signal and the at least one crank signal.

9. The method according to claim 8, wherein the virtual world is an animated world.

10. The method according to claim 8, wherein the directional device is an optical sensor.

11. The method according to claim 11, wherein said handle bar includes a handle support having a disk attached thereto, and further comprising the step of sensing rotation of the disk via the optical sensor.

12. The method according to claim 8, wherein said step of receiving at least one crank signal further comprises the steps of:
moving a disk in proximity to an optical sensor, wherein the movement of the disk is based on the rotation of the crank;
sensing movement of the disk at the optical sensor; and
generating the crank signal at the magnetic sensor.

13. The method according to claim 8, wherein said stationary cycle is sized for a child.

14. A system for navigating in a virtual world, the system comprising:
a stationary bicycle including a handlebar and a rotateable crank with two pedals;
a means for display;
at least one means for indicating direction connected to said handlebar;
at least one means for sensing arranged proximate to said moveable crank, said at least one means for sensing converting movement of said moveable crank into a crank signal; and
at least one means for processing operatively connected to said means for display, said at least one means for activating, and said at least one means for sensing, wherein said at least one means for processing provides virtual world content to said means for display, and wherein said at least one means for processing varies the virtual world content based at least in part on at least one of the directional signal and the crank signal.

15. The system according to claim 14, wherein the virtual world is an animated world.

16. The system according to claim 14, wherein said handlebar includes two handle grips, and wherein said at least one means for indicating direction includes a means for indicating direction on each of said handle grips.

17. The system according to claim 14, further comprising readable code resident on said means for processing, said readable code causing said means for processing to provide the virtual world content.

18. The system according to claim 14, wherein said stationary cycle is sized for a child.

19. A computer readable medium having code to cause a processor to navigate though a virtual world via a stationary cycle, the stationary cycle comprising a handlebar and a crank, said medium comprising:
code for displaying content related to a virtual world;
code for receiving at least one directional signal indicative of movement of the handlebar, the movement being by the user to indicate a direction;
code for receiving at least one crank signal indicative of rotational movement of the crank, the at least one crank signal being received from at least one sensor device arranged proximate the moveable crank; and
code for adjusting the content of the displayed virtual world based at least in part on at least one of the directional signal and the at least one crank signal.

20. The medium according to claim 19, wherein the virtual world is an animated world.

21. The medium according to claim 19, wherein said stationary cycle is sized for a child.
